(19) United States
(12) Patent Application Publication
(10) Pub. No.: US 2011/0010611 A1
(43) Pub. Date: Jan. 13, 2011

(54) AUTOMATED SEQUENTIAL MAGNIFICATION OF WORDS ON AN ELECTRONIC MEDIA READER

(76) Inventor: RICHARD ROSS, Pembroke Pines, FL (US)

Correspondence Address: RICHARD S. ROSS, ESQ., 4801 S. UNIVERSITY DR., # 237, FT. LAUDERDALE, FL, 33328, US

(21) Appl. No.: 12/499,164

(22) Filed: Jul. 8, 2009

(51) Int. Cl. G06F 17/25

(52) U.S. Cl. 715/204

(57) ABSTRACT

A method for displaying text of an e-book on an electronic media reader is disclosed. The method includes reading a rate setting that may be input by a user via a human input device. The method further includes reading a magnified text size setting input by the user via a human input device. The method further includes displaying on the electronic media reader a page of the e-book at a first text size that may be smaller than the magnified text size. The method further includes sequentially displaying subsequent words or groups of words of the page of the e-book at the magnified text size and at the rate, wherein only one word or one group of words may be displayed at the magnified text size at one time.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to electronic media readers, and more particularly to processes for facilitating the reading of words on an electronic media reader.

### BACKGROUND OF THE INVENTION

An electronic media reader, for example, an e-book reader or an e-book device, is a device used to display e-books. An e-book (short for electronic book) is a text based file that forms the digital media equivalent of a conventional printed book, often protected with a digital rights management system. E-books are usually read on personal computers or smart phones, or on dedicated hardware devices known as electronic media readers or e-book readers. An electronic media reader may be a device specifically designed for the purpose or reading e-books, or one intended for other purposes as well. The term electronic media reader is restricted to hardware devices, not software programs. Electronic media readers are typically, portable, light, and possess a long battery life, or can be in the form a stationary monitor and central processing unit such as a desktop computer.

Typically, an electronic media reader will display a single page of an e-book at a time, much like reading a physical book. When the user completes reading a page of the e-book, he presses a button or other input device to “turn the page” to the next page. One problem that users often encounter with electronic media readers is the size of the text of the e-book. Often, the default setting for the size of the text as displayed by the e-book can be too small for many readers. As a result, users are forced to squint or simply cope with small text, which can be uncomfortable and fatiguing to the eyes.

Some electronic media readers offer the ability to adjust the size of the text as displayed by the e-book so as to accommodate the text size preferred by the reader. The result of adjusting the size of the text to a larger size is that the amount of words displayed in a single page decreases. That is, when text size is set to a larger size, a displayed page holds fewer words, since each word takes up a larger amount of display space. Thus, when a user increases text size, a single page is read much quicker than before and consequently, the user must “turn the page” more often than before. This can be annoying and tedious for an individual. Further, when a user increases text size and the amount of words displayed in a single page decreases, the user loses the greater context of the current paragraph, sentence or word thought amid the surrounding e-book text. This can take away from a reading experience and reduce the enjoyment of a book.

Therefore, a need exists to overcome the problems with the prior art as discussed above, and particularly for a more efficient way to automate the display of words in an electronic media reader so as to facilitate a user reading an e-book.

### SUMMARY OF THE INVENTION

Briefly, in accordance with one embodiment of the present invention, a method for displaying text on an electronic media reader is disclosed. The method includes reading a rate setting and a magnified text size setting and displaying on the electronic media reader a page a first text size. The method further includes sequentially displaying subsequent words on the reader at the magnified text size and at the rate set. Optionally, as a teaching and learning tool, the reader can have its reading rate increased to encourage faster reading without loss of comprehension.

In another embodiment of the present invention, a computer readable medium embodying computer usable program code for displaying text of an e-book on an electronic media reader is disclosed. The computer readable medium comprises computer usable program code for reading a rate setting and a magnified text size setting and displaying on the electronic media reader a page of the e-book at a first text size. The computer readable medium further comprises computer usable program code for sequentially displaying subsequent groups of words of the page of the e-book at the magnified text size and at the rate.

In another embodiment of the present invention, an electronic media reader for facilitating the display text of an e-book is disclosed. The electronic media reader includes at least one human input device for reading information input by a user and a memory for storing a rate setting input by the user via the at least one human input device, a magnified text size setting input by the user via the at least one human input device and an e-book. The electronic media reader further includes a display for displaying a page of the e-book at a first text size and a processor configured for sequentially displaying subsequent groups of words of the page of the e-book at the magnified text size and at the rate.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a frontal view of an electronic media reader facilitating the display of words of an e-book, in accordance with one embodiment of the present invention.

FIG. 2 is a flowchart displaying the control flow of the text display process of an electronic media reader, in accordance with one embodiment of the present invention.

### DETAILED DESCRIPTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing, like numerals refer to like parts through several views.

The present invention, according to a preferred embodiment, overcomes problems with the prior art by providing a user-adjustable magnified text setting that allows the user to define the text size of the text currently being read by the user. The present invention also allows the user to define the rate at which the magnified set of words moves across and down the page. The aforementioned features allow a user a more customizable reading experience. The present invention further solves problems with the prior art by allowing the entire page of an e-book to be displayed at a first text size while allowing only a word or group of words to be displayed at a magnified text size for reading. This allows more words to be displayed on the screen at one time, thereby maintaining the greater context of the current sentence or word amid the surrounding e-book text. This preserves the reading experience and enjoyment of a book.

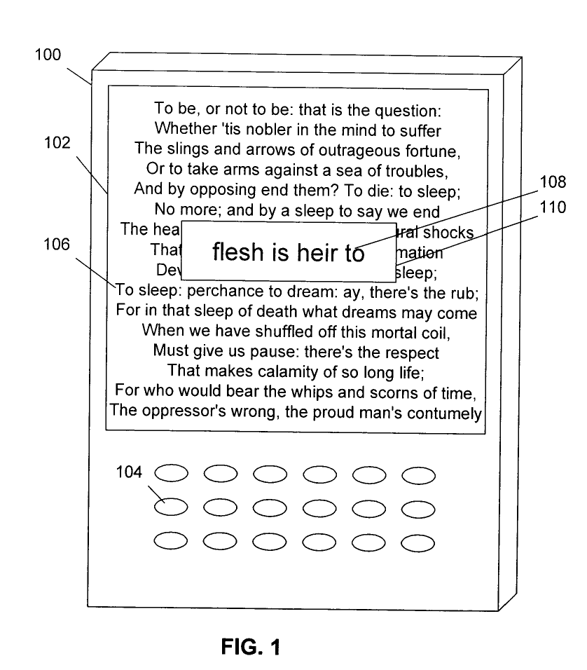

FIG. 1 is an illustration of a frontal view of an electronic media reader 100 facilitating the display of words of an e-book, in accordance with one embodiment of the present invention. FIG. 1 shows that the electronic media reader 100 includes a display 102 (which may be a touch screen) and buttons 104, which may act as human input devices. The electronic media reader 100 of FIG. 1 may also include other human input devices such as a mouse, a touch screen, a stylus, a house, a touch pad or the like. The aforementioned human input devices can be used by the user to enter settings, such as a first font or text size for displaying a page of an e-book, a magnified font or text size for displaying a word or group of words of an e-book and a rate at which each sequential word or group of words is displayed.

FIG. 1 shows that the display 102 of the electronic media reader 100 is displaying a page 106 comprising a set of sequential words of an e-book. Note that the words of the page 106 are displayed at a first text or font size. FIG. 1 also shows that the electronic media reader 100 is displaying a group of words 108 of the e-book at a magnified text size greater than the first text size. Note that the group of words 108 is displayed in an opaque box 110 that occludes or obstructs certain words in the page 106. In another embodiment of the present invention, the box 110 can be transparent or semi-transparent such that the words in the page 106 are not completely occluded or obstructed by box 110. In yet another embodiment of the present invention, the lines of words in page 106 are spaced apart enough to allow box 110 to be displayed such that the words in the page 106 are not occluded or obstructed by box 110.

FIG. 1 shows that the box 110 magnifies a group of words 108 of page 106. The box 110 moves sequentially across and down the page 106 magnifying groups of words 108 as a human reads the magnified words. When the last word or group of words of the page 106 has been magnified, the electronic media reader 100 clears the display 102 and proceeds to display a subsequent page of the e-book. Although FIG. 1 shows that box 110 magnifies a group of words 108, the present invention supports the magnification of a single word at a time, a user-defined number of words at a time, a user-defined number of characters at a time or a sentence at a time.

It should be noted that as the box 110 moves sequentially across and down the page 106 magnifying groups of words 108, only the set of words chosen for magnification are displayed at the magnified text size. The remaining words of the page 106 are displayed at the first text size, smaller than the magnified text size. As the box 110 moves to a subsequent group of words to magnify, the currently magnified group of words are reduced back to the first text size and the subsequent group of words are magnified to the magnified text size.

The first text or font size at which the words of the page 106 are displayed in display 102 of FIG. 1 is adjustable by the user since the user can define the first text or font size using a human input device. Similarly, the magnified text size at which the words 108 of the box 110 are displayed in display 102 of FIG. 1 is adjustable by the user. Also, the rate at which the box 110 moves sequentially from word-to-word, or group of words-to-group of words, is adjustable by the user.

Buttons 104 may include a button for a “play” command that starts the page display process and the word magnification process as described herein. Buttons 104 may also include buttons for a “reverse” and a “forward” command that reverses or forwards the current page or magnified group of words. Reversing or forwarding may occur in increments of words, sentences, paragraphs or chapters. Buttons 104 may also include buttons for a “pause” and a “stop” command that stops or pauses the current page or magnified group of words.

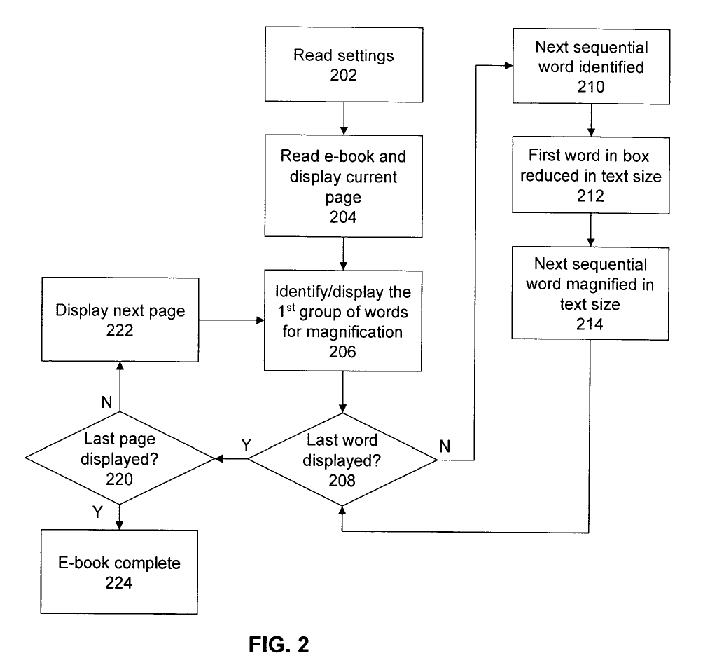

FIG. 2 is a flowchart displaying the control flow of the text display process of an electronic media reader 100, in accordance with one embodiment of the present invention. In step 202, a processor of the electronic media reader 100 reads from memory a first text size at which to display the words of a page 106, a magnified text size at which to magnify a group of words 108 of the page 106, and a rate at which to sequentially display the group of words 108 of the page 106. In step 204, the processor of the electronic media reader 100 reads the e-book from memory, selects the page of the e-book to display and displays in the display 102 the text of the selected page of the e-book at the first text size.

In step 206, the processor of the electronic media reader 100 identifies the first group of words in the displayed page and displays the group of words in a box 110 at the magnified text size. In step 208, it is determined if the last word of the displayed page has been displayed in the box 110. If the result of the determination of step 208 is negative, control flows to step 210. Otherwise, control flows to step 220. In step 210, the next sequential word to be displayed is identified. In step 212, the first word of the group of words in box 110 is dropped from the box 110 and reduced in size back to the first text size. In step 214, the next sequential word identified in step 210 is inserted at the last word in the box 110 and displayed at the magnified text size.

In step 220, it is determined if the last page of the e-book has been displayed in the display 102. If the result of the determination of step 220 is negative, control flows to step 222 where the next page of the e-book is displayed in the display 102 at the first text size. Otherwise, control flows to step 220. In step 224, the e-book is completed.

In one embodiment of the present invention, the user of the electronic media reader 100 may press a button 104 to indicate a “power off” command to turn off the electronic media reader 100. Responsive to this command, a processor of the electronic media reader 100 may store in memory an identifier that indicates the current page and word being displayed in display 102. Subsequently, the user of the electronic media reader 100 may press a button 104 to indicate a “power on” command to turn on the electronic media reader 100. Responsive to this command, the processor of the electronic media reader 100 may read the identifier from memory. In this embodiment, the identifier is used in steps 204 and 206 to identify the current page and group of words to display in the display 102. This allows a user to easily and seamlessly return to the page and words where he left off the last time he was reading the e-book.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer usable or computer readable medium providing program code for use by or in connection with a computer or any instruction execution system.

For the purposes of this description, a computer usable or computer readable medium can be any apparatus that can contain or store the program of the present invention for use by or in connection with the instruction execution system, apparatus, or device. The computer readable medium can be a hard disk, a flash drive, a floppy disk or the like. Further, examples of a computer readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system, such as the electronic media reader 100, suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for displaying text on an electronic media reader, comprising:
processing a reading rate setting;
processing a magnified text size setting;
displaying text at a first text size; and
sequentially displaying subsequent text at the magnified text size and at the reading rate set.

2. The method of claim 1, wherein the step of processing a reading rate setting further comprises:
processing a reading rate setting input by a user via a human input device wherein said reading rate setting is adjustable by said user.

3. The method of claim 2, wherein the step of processing a magnified text size setting further comprises:
processing a magnified text size setting input by the user via a human input device.

4. The method of claim 3, further comprising:
reading a first text size setting input by the user via a human input device.

5. The method of claim 1, wherein the step of sequentially displaying further comprises:
sequentially displaying subsequent text on the electronic media reader at the magnified text size and at the reading rate set, wherein only one word of text is displayed at time at the magnified text size.

6. The method of claim 1, wherein the step of sequentially displaying further comprises:
sequentially displaying subsequent text on the electronic media reader at the magnified text size and at the reading rate set, wherein only one group words of text is displayed at a time at the magnified text size.

7. The method of claim 1, further comprising:
displaying a subsequent screen of text of the electronic media reader at the first text size, responsive to displaying a last word of the text on the previous screen of the electronic media reader at the magnified text size.

8. The method of claim 7, further comprising:
sequentially displaying text on the subsequent screen of the electronic media reader at the magnified text size and at the reading rate set.

9. The method of claim 1, further comprising:
storing an identifier for current text of the electronic media reader being displayed, responsive to detecting a command to power-off the said reader.

10. The method of claim 9, further comprising:
displaying text of the electronic media reader corresponding to the identifier that was stored, responsive to detecting a command to power-on the said reader.

11. A computer readable medium embodying computer usable program code for displaying text of an e-book on an electronic media reader, the computer readable medium comprising computer usable program code for:
reading a rate setting;
reading a magnified text size setting;
displaying on the electronic media reader a page of the e-book at a first text size; and
sequentially displaying subsequent text on the page of the e-book at the magnified text size and at the reading rate set.

12. The computer readable medium of claim 11, wherein the computer usable program code for reading a rate setting further comprises computer usable program code for:
reading a rate setting input by a user via a human input device wherein said reading rate setting is adjustable by said user.

13. The computer readable medium of claim 12, wherein the computer usable program code for reading a magnified text size setting further comprises computer usable program code for:
reading a magnified text size setting input by the user via a human input device.

14. The computer readable medium of claim 13, further comprising computer usable program code for:
displaying a subsequent page of the e-book at the first text size, responsive to displaying a last word or group of words of the page of the e-book at the magnified text size.

15. The computer readable medium of claim 14, further comprising computer usable program code for:
sequentially displaying text on the subsequent page of the e-book at the magnified text size and at the reading rate set.

16. An electronic media reader for facilitating the display text of an e-book, comprising:
at least one human input device for reading information input by a user;
a memory for storing a reading rate setting input by the user via the at least one human input device, a magnified text size setting input by the user via the at least one human input device and an e-book;
a display for displaying a page of the e-book at a first text size; and
a processor configured for sequentially displaying subsequent text on the page of the e-book at the magnified text size and at the reading rate set.

17. The electronic media reader of claim 16, wherein the processor is further configured for:
displaying a subsequent page of the e-book at the first text size, responsive to displaying a last group of words of the page of the e-book at the magnified text size.

18. The electronic media reader of claim 17, wherein the processor is further configured for:
sequentially displaying text on the subsequent page of the e-book at the magnified text size and at the rate.

19. The electronic media reader of claim 18, wherein the memory is further configured for storing an identifier for a current word and page of the e-book being displayed, responsive to detecting a command to power-off the electronic media reader.

20. The electronic media reader of claim 19, wherein the processor is further configured for:
displaying the word and page of the e-book corresponding to the identifier that was stored, responsive to detecting a command to power-on the electronic media reader.
